(19) United States
(12) Patent Application Publication
(10) Pub. No.: US 2024/0129934 A1
(43) Pub. Date: Apr. 18, 2024

(54) RANGE CONTROL FOR NR-SL BASED AIR-TO-AIR COMMUNICATIONS

(71) Applicant: QUALCOMM Incorporated, San Diego, CA (US)

(72) Inventors: Qiaoyu LI, Beijing (CN); Kangqi LIU, San Diego, CA (US); Hao XU, Beijing (CN)

(21) Appl. No.: 18/277,369

(22) PCT Filed: Apr. 29, 2021
(86) PCT No.: PCT/CN2021/090857

§ 371 Date: Aug. 15, 2023

(51) Int. Cl. H04W 72/25; H04B 7/185

(52) U.S. Cl. CPC H04W 72/25; H04B 7/18506

(57) ABSTRACT

The first UE may transmit to the second UE, via an SCI-2 message in a PSSCH, an indication of at least one of a 3D zone ID associated with the first UE or a 3D communication range associated with the first UE. The second UE may determine whether the second UE is in a communication range based on the received indication of the at least one of the 3D zone ID associated with the at least one first UE or the 3D communication range associated with the at least one first UE. The second UE may determine whether to transmit an ACK or a NACK based on whether the second UE is in the communication range. The second UE may transmit to the first UE an ACK or a NACK based on whether the at least one second UE is in a communication range.

### BACKGROUND

### Technical Field

The present disclosure relates generally to communication systems, and more particularly, to range control in sidelink air-to-air communications.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first (transmitting) user equipment (UE). The apparatus may transmit, to at least one second UE via a sidelink control information (SCI) format 2 (SCI-2) message in a physical sidelink shared channel (PSSCH), an indication of at least one of a three-dimensional (3D) zone identifier (ID) associated with the first UE or a 3D communication range associated with the first UE. The apparatus may receive, from the at least one second UE, an acknowledgement (ACK) or a negative acknowledgement (NACK) based on whether the at least one second UE is in a communication range.

In an aspect of the disclosure, a method, a computer-readable medium, and an apparatus are provided. The apparatus may be a second (receiving) UE. The apparatus may receive, from at least one first UE via an SCI-2 message in a PSSCH, an indication of at least one of a 3D zone ID associated with the at least one first UE or a 3D communication range associated with the at least one first UE. The apparatus may determine whether the second UE is in a communication range based on the received indication of the at least one of the 3D zone ID associated with the at least one first UE or the 3D communication range associated with the at least one first UE. The apparatus may determine whether to transmit an ACK or a NACK based on whether the second UE is in the communication range.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating wireless communications in non-terrestrial networks (NTN), and in particular, air-to-ground (ATG) communications.

FIG. 5 is a diagram illustrating example air-to-air (A2A) sidelink communications.

FIG. 6A is a diagram illustrating an example configuration of antennas/antenna elements on the tailplane of the aircraft.

FIG. 6B is a diagram illustrating an example configuration of antennas/antenna elements on the front edge of the aircraft.

FIG. 7 is a diagram illustrating example two-dimensional (2D) sidelink range control.

FIG. 8 is a diagram illustrating issues associated with A2A sidelink range control.

FIG. 9 is a diagram illustrating an example sidelink communication. The SCI may be transmitted in two stages for forward compatibility.

FIGS. 10A and 10B are diagrams illustrating identification of 3D zones.

FIGS. 11A and 11B are diagrams illustrating distance-based 3D range control.

FIGS. 12A and 12B are diagrams illustrating distance-based 3D range control.

FIGS. 13A and 13B are diagrams illustrating zone-based 3D range control.

FIG. 14 is a communication flow of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus.

FIG. 20 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

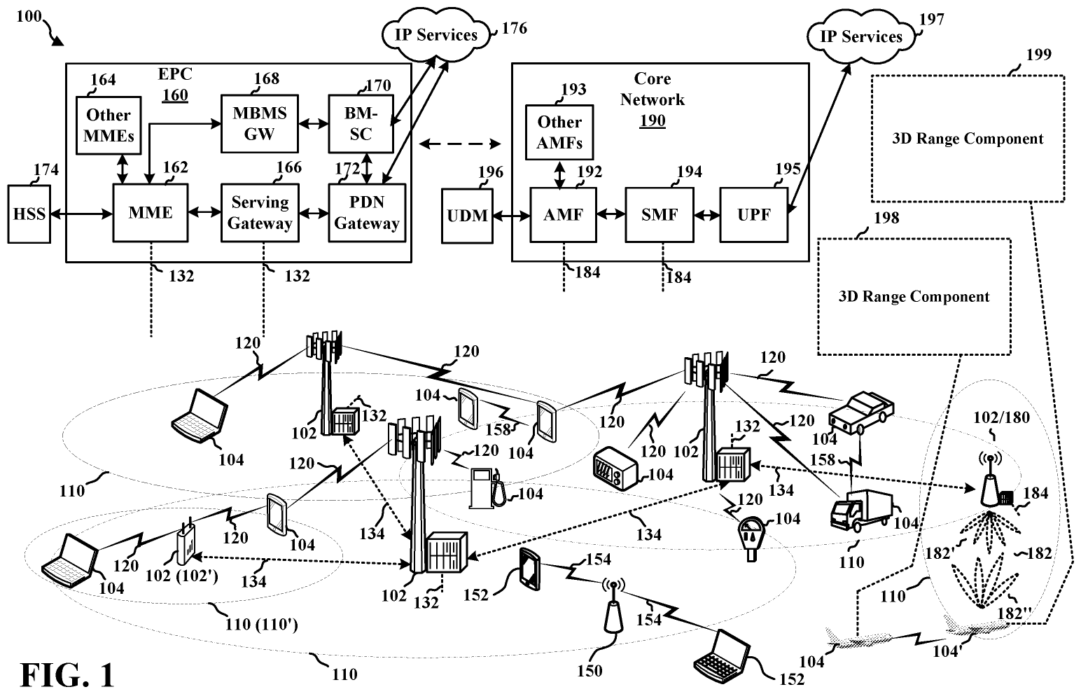

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronic s Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the first UE 104 may include a 3D range component 198 that may be configured to transmit, to at least one second UE via an SCI-2 message in a PSSCH, an indication of at least one of a 3D zone ID associated with the first UE or a 3D communication range associated with the first UE. The 3D range component 198 may be configured to receive, from the at least one second UE, an ACK or a NACK based on whether the at least one second UE is in a communication range. In certain aspects, the second UE 104′ may include a 3D range component 199 that may be configured to receive, from at least one first UE via an SCI-2 message in a PSSCH, an indication of at least one of a 3D zone ID associated with the at least one first UE or a 3D communication range associated with the at least one first UE. The 3D range component 199 may be configured to determine whether the second UE is in a communication range based on the received indication of the at least one of the 3D zone ID associated with the at least one first UE or the 3D communication range associated with the at least one first UE. The 3D range component 199 may be configured to determine whether to transmit an ACK or a NACK based on whether the second UE is in the communication range. Although the following description may be focused on 5G NR, the concepts described herein may be applicable to other similar areas, such as LTE, LTE-A, CDMA, GSM, and other wireless technologies.

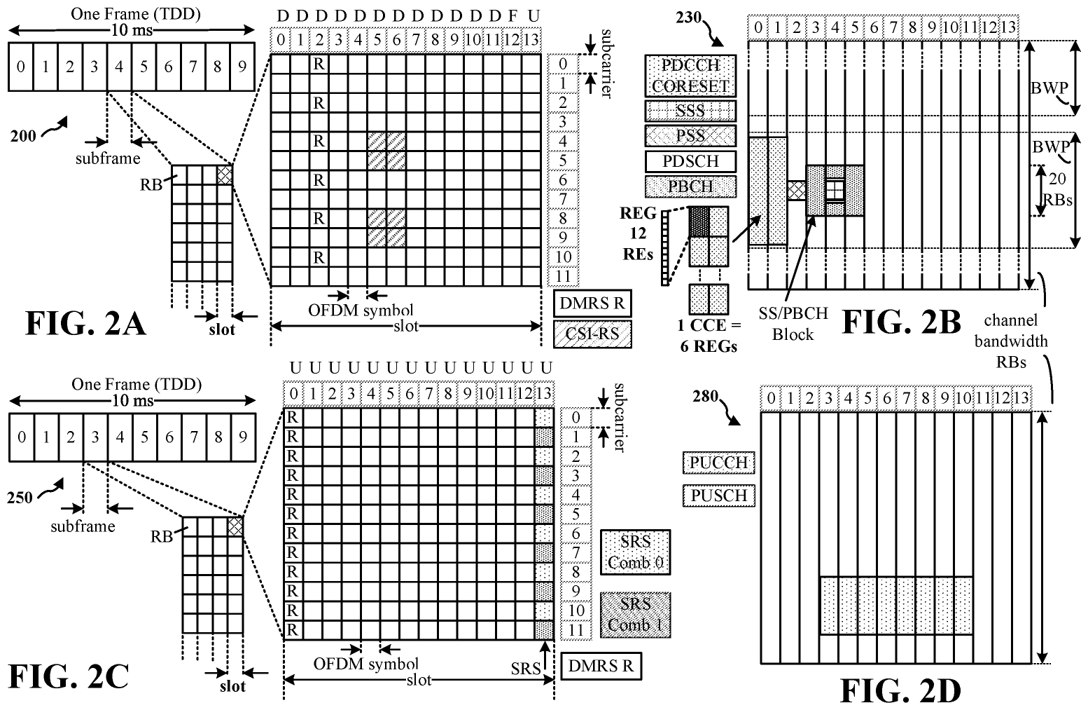

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2μ*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

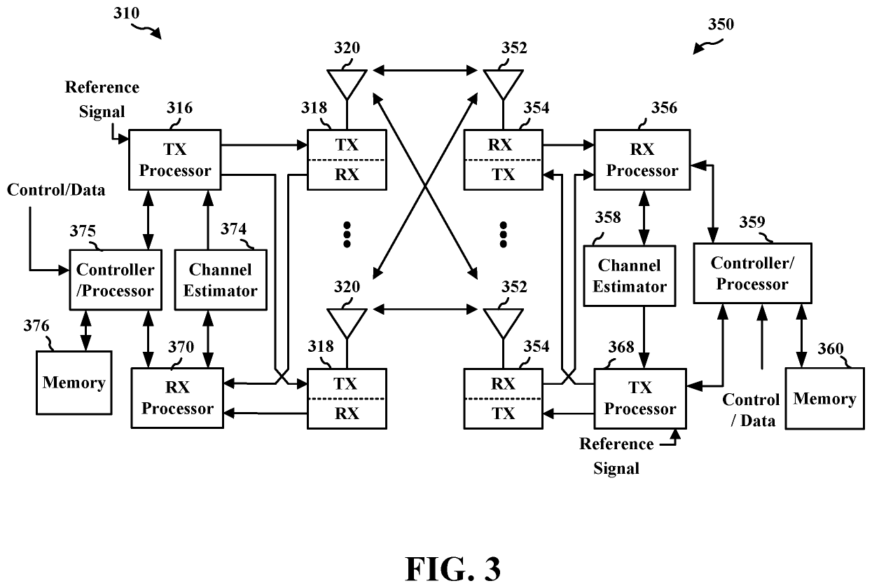

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BP SK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 and 199 of FIG. 1.

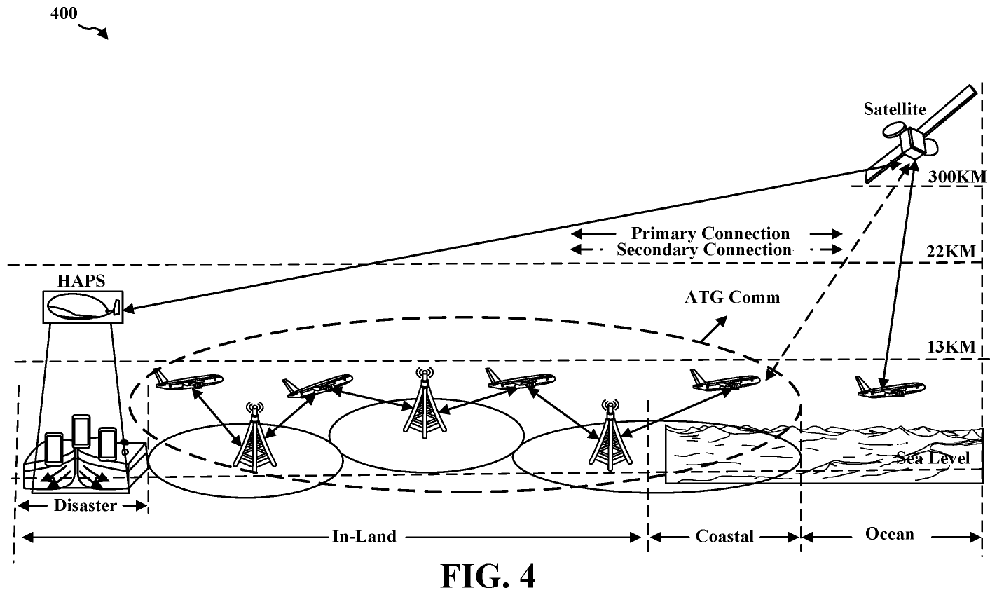

FIG. 4 is a diagram 400 illustrating wireless communications in non-terrestrial networks (NTN), and in particular, air-to-ground (ATG) communications. ATG communications may take place between aircraft UEs in the air and ground-based base stations when the aircraft UEs are in an in-land or coastal area. The ground-based base stations may be equipped with up-tilting antennas for communication with aircraft UEs in the air, and the aircraft UEs may be equipped with antennas at the bottom of the aircraft for communication with ground-based base stations. Compared to satellite-based communications (which, for example, can be used when the aircraft UE is above an ocean), ATG communications are associated with a lower cost, a higher throughput, and a lower latency. The data traffic that may be carried over ATG communications may include aircraft passenger communications (e.g., communications associated with the passengers' own devices), air traffic management communications, and/or aircraft surveillance or maintenance communications.

In one aspect, FDD may be utilized for core specification work for NR-NTN. TDD may also be used in certain scenarios (e.g., for high altitude platform stations “HAPS” or ATG). ATG communications may be associated with a large inter-site distance (ISD) and a large coverage range. In order to control the network deployment cost and considering a limited number of flights, a large ISD, e.g., about 100 kilometers (km) to 200 km, may be utilized. At the same time, when the aircraft is above the sea, the distance between the aircraft and the nearest base station may be more than 200 km and up to 300 km. Therefore, an ATG network may be able to provide a cell coverage range of up to 300 km. Non-disjoint operators' proprietary frequencies may be utilized for deploying both ATG and terrestrial networks. Operators may be interested in adopting the same frequency for deploying both ATG and terrestrial networks to save the frequency resource cost, while interference between ATG and terrestrial networks may become nonnegligible and may be addressed. Certain frequency bands, e.g., sub-6 GHz, may be used for the ATG network. In particular, the 4.8 GHz frequency band may be used for deploying both ATG and terrestrial NR networks. The on-board ATG terminal may be more powerful than a normal terrestrial UE, e.g., with a higher effective isotropic radiated power (EIRP) via a higher transmission power and/or a larger on-board antenna gain (e.g., a larger beamforming gain). The ATG network deployment may be associated with a number of particular aspects. For example, an ATG network may have a large cell coverage range (e.g., up to 300 km), and may be associated with a high flight speed (e.g., up to 1200 kilometers per hour (km/h)). ATG and terrestrial networks may coexist. Base stations and UEs for an ATG network may be associated with core and performance specifications.

A number of PHY layer challenges may be present in NR-NTN. To avoid frequent handovers and reduce inter-cell interference, a large ISD may be utilized, which may be associated with a large tracking area. The ISD may be 100 km to 200 km in an in-land area. Along coasts, a coverage distance of up to 300 km may be possible. A high per-cell throughput may be specified. For example, a data rate of over 1 Gbps per aircraft may be specified. The data traffic bandwidth for each aircraft may be up to 1.2 Gbps in downlink, and up to 600 Mbps in uplink. As to the density of the aircraft, there may be approximately 60 aircraft in a coverage area of approximately 18,000 km² (i.e., the coverage distance per cell may be approximately 134 km).

For ATG communications, ground-based base stations may be equipped with up-tilting antennas with various tilting angles. The aircraft UE antenna, potentially with beamforming capabilities, may be mounted at the bottom of the aircraft.

A number of link budget assumptions for simulation of the ATG communications may be utilized. Herein the #UE-ant-elements may refer to the number of antenna elements in the UE. #UE-TxRUs may refer to the number of transceiver units in the UE. UE-ant-element-gain may refer to the antenna element gain in the UE. In one aspect, {#UE-ant-elements, #UE-TxRUs, UE-ant-element-gain} may be {8, 8, 0 dBi}, {32, 8, 0 dBi}, or {32, 8, 8 dBi}. The free space path loss may be assumed (e.g., for en-route, climb, and descent). In another aspect, the antenna element gain in the base station may be 8 dBi. Herein #gNB-ant-elements may refer to the number of antenna elements in a base station. #gNB-TxRUs may refer to the number of transceiver units in a base station. #gNB-TxChains may refer to the number of transmit chains in a base station. For the 4.8 GHz and 3.5 GHz frequency bands, {#gNB-ant-elements, #gNB-TxRUs, #gNB-TxChains in LLS} may be {192, 64, 4}. For the 700 MHz frequency band, {#gNB-ant-elements, #gNB-TxRUs, #gNB-TxChains in LLS} may be {4, 4, 4}. The maximum path loss (MPL) may be calculated considering different frequency bands and different specified signal-to-noise ratios (SNRs). A high number of antenna elements and a high antenna element gain may be specified at the UE's side (e.g., especially for the 4.8 GHz or the 3.5 GHz frequency band).

To sustain the high throughput and the large coverage area of an ATG network, the ATG transmit power may exceed what is permitted by local regulations, especially at the 4.8 GHz frequency band. For example, in a typical scenario with the 4.8 GHz frequency band and a coverage distance of 100 km, a transmit power of approximately 2 kilowatts (kW) may be specified. If the coverage distance expands to 300 km, a transmit power of approximately 20 kW may be specified.

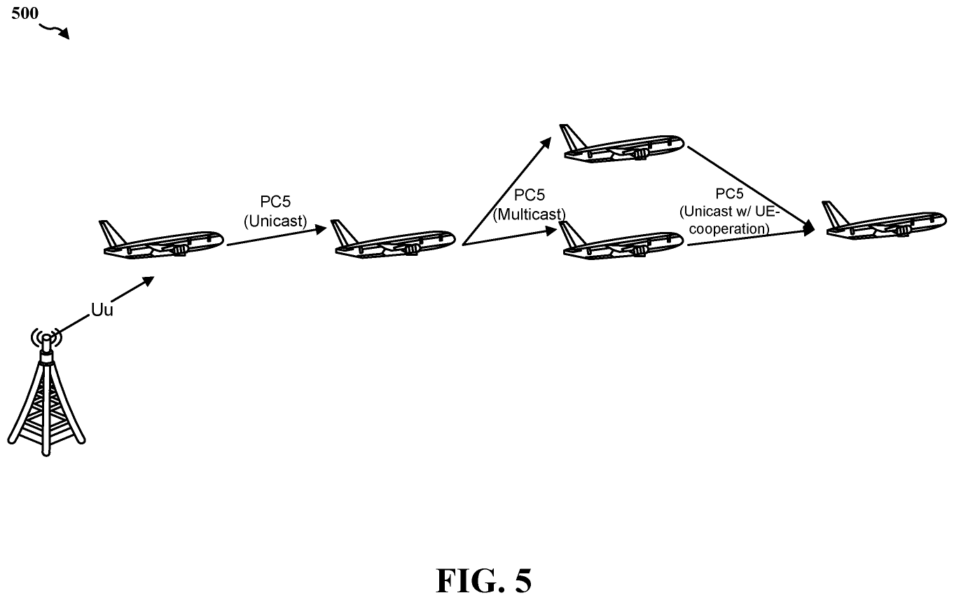

Sidelink communication may help to improve throughput in ATG networks. FIG. 5 is a diagram 500 illustrating example air-to-air (A2A) sidelink communications. In NR, a sidelink based relay or repeater may help to relax the base station transmit power specification, and may help to maintain the UEs' throughput at the cell-edge. The A2A sidelink communications may also be associated with additional benefits. For example, commercial aircraft may typically line up (with a distance of approximately 10 km in between) and fly in predetermined air-routes to optimize fuel consumption and air traffic control. Accordingly, sidelink relays or repeaters may be utilized (over a PC5 interface) for coverage extension. In a congested airspace, different aircraft may be layered in different flight levels (FLs). Adjacent FLs may be approximately 1000 feet (ft) (or 0.6 km) apart in altitude. An FL may correspond to an altitude, an altitude range, an altitude set, or a height of flight, etc. Accordingly, sidelink-based multicast may be utilized to improve reliability and throughput. In addition, cooperative sidelink-based unicast with UE cooperation may help to increase spatial diversity.

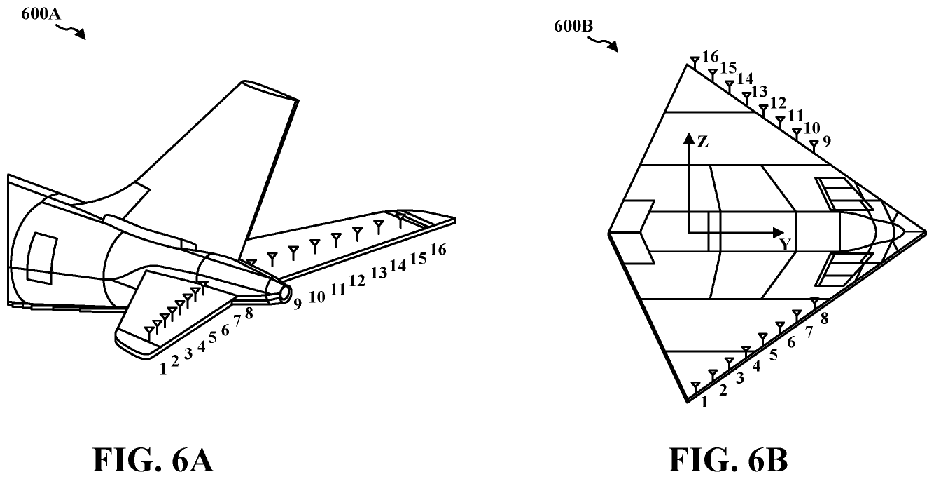

To enable A2A beamforming, additional aircraft UE antennas or antenna elements may be mounted on wings and/or tails of the aircraft. FIG. 6A is a diagram 600A illustrating an example configuration of antennas/antenna elements on the tailplane of the aircraft. FIG. 6B is a diagram 600B illustrating an example configuration of antennas/antenna elements on the front edge of the aircraft.

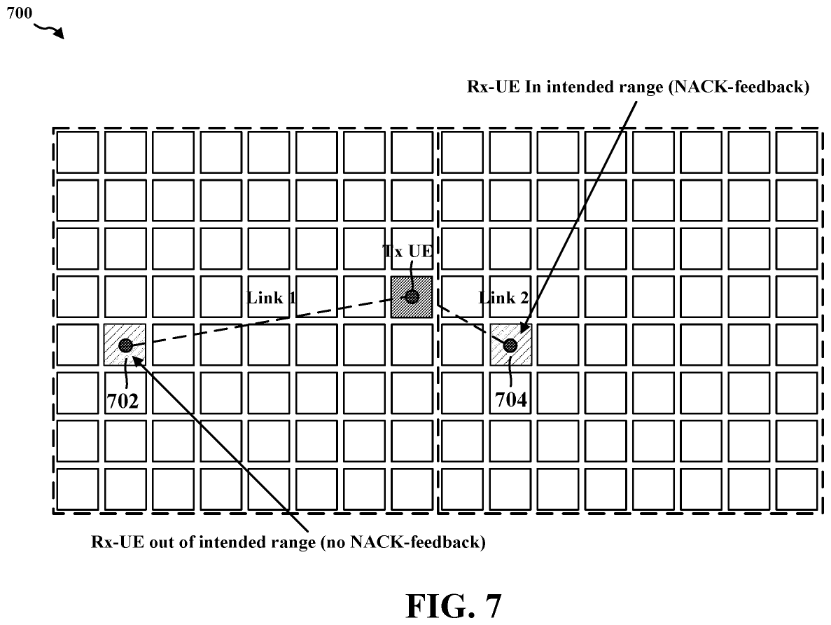

FIG. 7 is a diagram 700 illustrating example two-dimensional (2D) sidelink range control. The range control mechanism illustrated in FIG. 7 may be applicable in 2D scenarios (e.g., for vehicles). For distance-based acknowledgement (ACK)/negative acknowledgement (NACK)-feedback in sidelink-groupcast, the transmit UE's zone identifier (ID) and communication range specification may be included in a sidelink control information (SCI) format 2 (SCI-2) message via a physical sidelink shared channel (PSSCH) (e.g., Format-2B). The zone IDs may be defined in rectangular 2D grids. A receiving UE may identify whether it is within the specified range based on the distance between its own zone ID and the received zone ID of the transmit UE. A receiving UE 704 that is within the specified range and is successful in decoding the PSSCH may transmit an ACK feedback. A receiving UE 704 that is within the specified range and has failed to decode the PSSCH may transmit a NACK feedback A retransmission may then be scheduled based on the NACK feedback. A receiving UE 702 that is outside the specified range may not transmit any feedback (ACK or NACK).

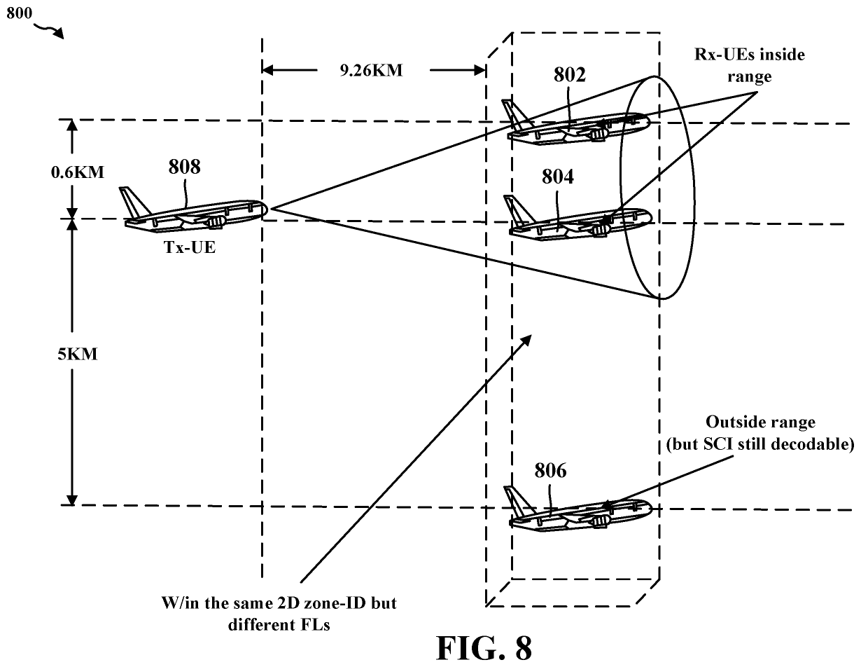

FIG. 8 is a diagram 800 illustrating issues associated with A2A sidelink range control. In A2A sidelink communications, aircraft within the same 2D grid may be at various different FLs. UEs in FLs far away from the transmit UE's FL may be out-of-coverage, as the transmit UE's beam may not cover the faraway FLs. In other words, the 2D grid-based range control mechanism described above may be insufficient for identifying some of the out-of-coverage UEs because these UEs may be located within in-range 2D grids but may actually be out-of-coverage due to the difference in FLs. For example, the aircraft UE 802, 804, 806 may be located within the same 2D grid and associated with the same 2D zone ID. The aircraft UE 802, 804 may be within the communication range of the transmit aircraft UE 808. On the other hand, the aircraft UE 806 may be outside the communication range of the transmit aircraft UE 808 because the altitude difference in the respective FLs. Because the SCI-2 may be transmitted with a sufficiently low data rate, the out-of-coverage aircraft UE 806 may be able to decode the SCI-2 in the PSSCH, but may not be able to decode the data portion of the PSSCH because the aircraft UE 806 is out-of-coverage. Based purely on the 2D grids and the 2D zone IDs, the aircraft UE 806 may not be able to identify that it is outside the communication range of the transmit aircraft UE 808 as the FL difference information is missing, and may accordingly transmit a NACK feedback to signal the failure to decode the data portion of the PSSCH. Based on the NACK feedback, the transmit aircraft UE 808 may schedule one or more retransmissions of the data portion. The resources used for the retransmissions may then be wasted as the aircraft UE 806 is actually out-of-coverage and may never be able to decode the retransmissions. Thus, a 3D range control mechanism for A2A sidelink communications may be advantageous.

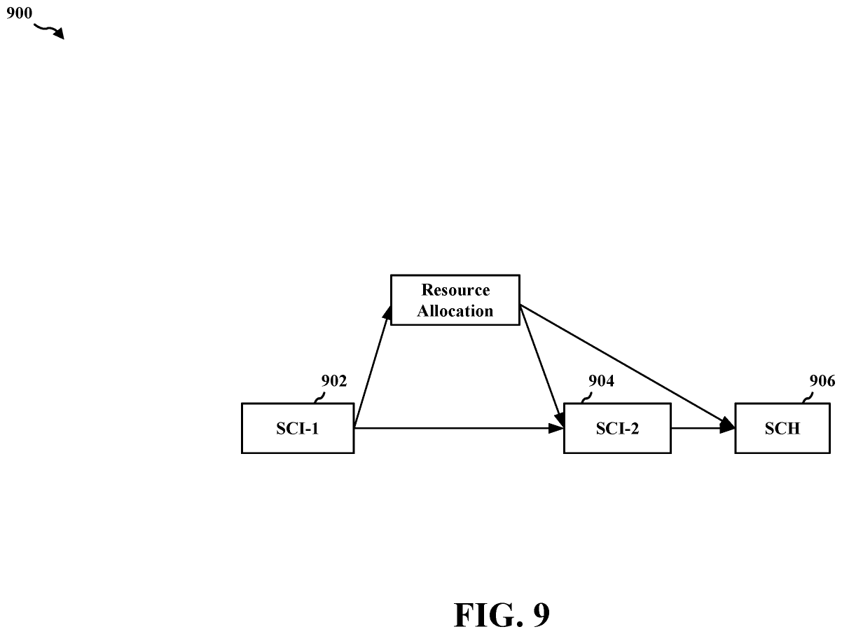

FIG. 9 is a diagram 900 illustrating an example sidelink communication. The SCI may be transmitted in two stages for forward compatibility. The first stage control (e.g., an SCI format 1 “SCI-1” message 902) may be transmitted on a physical sidelink control channel (PSCCH) and may contain information for resource allocation and for decoding the second stage control. The second stage control (e.g., an SCI-2 message 904) may be transmitted on a PSSCH and may contain information for decoding data (transmitted on the shared channel “SCH” 906). The SCI-1 messages may be decodable by UEs in all releases, whereas the SCI-2 messages may be introduced in future releases. Therefore, new features may be introduced, while resource collisions between releases may be avoided. Both SCI-1 messages and SCI-2 messages may use the PDCCH polar code.

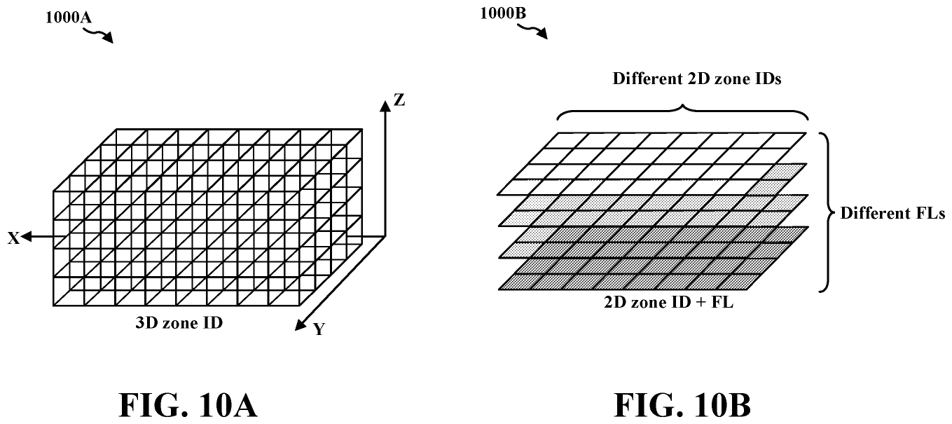

FIGS. 10A and 10B are diagrams 1000A and 1000B, respectively, illustrating identification of 3D zones. A receiving aircraft UE may receive an SCI-2 message via a PSSCH. The SCI-2 message may include an indication of the transmit aircraft UE's 3D zone ID. FIG. 10A illustrates native 3D zone IDs, which may be defined by dividing the 3D airspace into 3D cubes. Each 3D cube may be associated with a (native) 3D zone ID. The size of the 3D cubes may be configured via RRC signaling (e.g., received from a base station).

FIG. 10B illustrates 2D zone-based 3D zone IDs each of which may be a combination of a 2D zone ID (as described above) and an FL ID. The altitude difference between adjacent indicated FLs may be configured via RRC signaling (e.g., received from a base station). In one aspect, the SCI-2 message may be scheduled by an SCI-1 message, and the format of the SCI-2 message and/or the parameters associated with the 3D zone IDs may be indicated by the SCI-1 message in advance. For example, the SCI-1 message may indicate whether the 3D zone ID is used, or which type of 3D zone ID (e.g., native or 2D zone-based) is used.

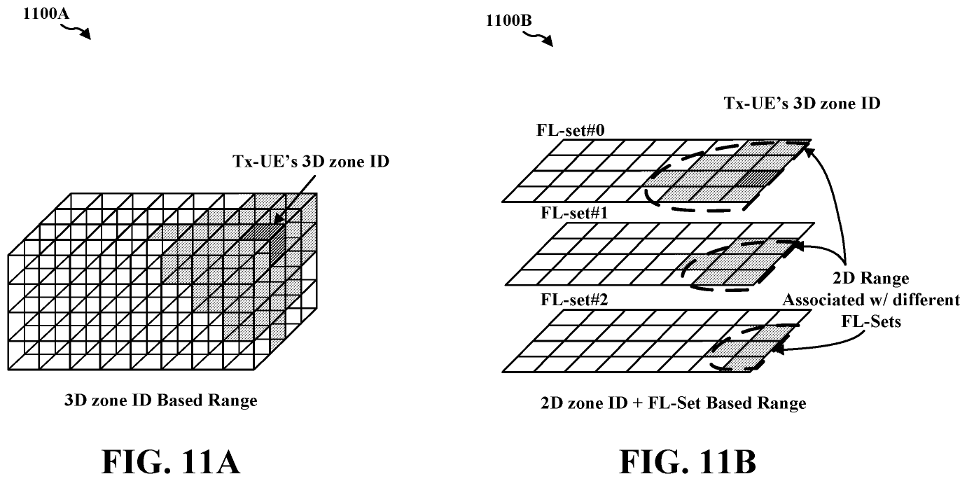

FIGS. 11A and 11B are diagrams 1100A and 1100B, respectively, illustrating distance-based 3D range control. A receiving aircraft UE may receive an SCI-2 message via a PSSCH. The SCI-2 message may include a distance-based indication of a 3D range. FIG. 11A illustrates distance (range)-based 3D range control where the native 3D zone IDs are used. The range may be indicated based on the transmit aircraft UE's indicated 3D zone ID and a distance expressed as a number of 3D zones towards the receiving aircraft UE's identified 3D zone. The 3D zones may be defined within the 3D airspace. Native 3D zone IDs described above may be used to identify the transmit aircraft UE's and the receiving aircraft UE's 3D zones.

FIG. 11B illustrates distance (range)-based 3D range control where the 2D zone-based 3D zone IDs are used. The ranges may be indicated per FL. At each FL, the range may be indicated based on the transmit aircraft UE's indicated 2D zone ID and a distance expressed as a number of 2D zones towards the receiving aircraft UE's identified 2D zone. 2D zone-based 3D zone IDs described above may be used to identify the transmit aircraft UE's and the receiving aircraft UE's 3D zones. The per FL ranges may be indicated in a differential manner. In particular, FLs closer to the transmit aircraft UE's FL may be associated with greater ranges. FLs farther from the transmit aircraft UE's FL may be associated with shorter ranges, which may be indicated in a differential manner. For example, a range of one FL (e.g., a second FL) may be indicated in the SCI-2 message as a difference between the indicated range of another FL (e.g., a first FL) and the range of the FL (e.g., the second FL).

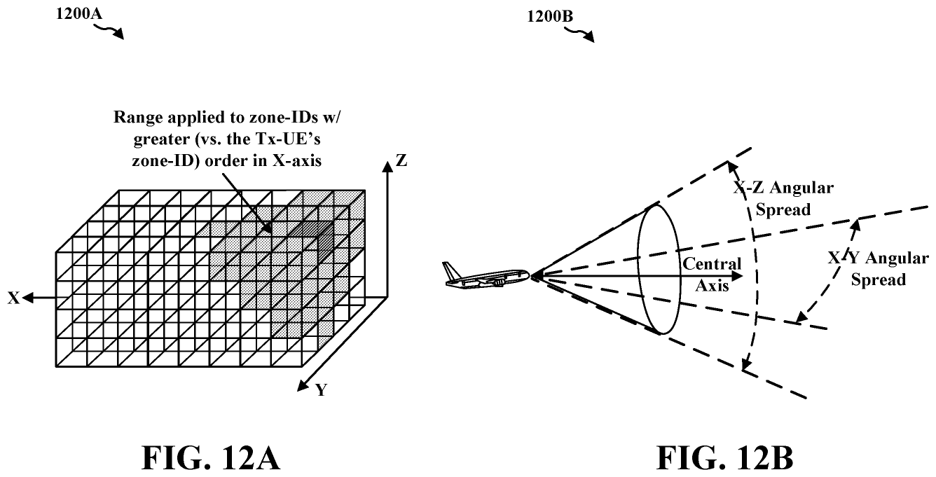

FIGS. 12A and 12B are diagrams 1200A and 1200B, respectively, illustrating distance-based 3D range control. In one aspect, the indicated range may be applicable to 3D zones whose 3D zone IDs are greater than the transmit aircraft UE's 3D zone ID in the X- and/or Y-axis. This may be based on the fact that a transmit aircraft UE may transmit A2A sidelink communications mainly to receiving aircraft UEs in a front-facing direction of travel (either traveling in the same direction or in the opposite direction). FIG. 12A illustrates the application of the indicated range to 3D zones whose 3D zone IDs are greater than the transmit aircraft UE's 3D zone ID in the X-axis. In one aspect, a decrease or an increase in ranges in the X- and/or Y-axis may be indicated in the SCI-2 message or predetermined.

In one aspect, one or more 3D angular spreads (e.g., X-Y and/or X-Z angular spreads) may be indicated in the SCI-2 message in addition to the range indication. FIG. 12B illustrates the indication of the X-Y (azimuth) and X-Z (elevation) angular spreads. The angular spreads may be defined with reference to a central axis in the 3D airspace, which may be preconfigured or predetermined. A receiving aircraft UE may identify its angle(s) from the central axis. A receiving aircraft UE may be outside the communication range when it is outside the indicated angular spreads even if its distance to the transmit aircraft UE is sufficiently close. A receiving aircraft UE may be inside the communication range when it is inside the indicated angular spreads and its distance to the transmit aircraft UE is sufficiently close.

In one aspect, a receiving aircraft UE may transmit a NACK feedback when it is within the indicated range and fails to decode the data portion of the PSSCH. A receiving aircraft UE may not transmit any feedback when it is outside the indicated range, so that no resources are wasted on retransmission attempts.

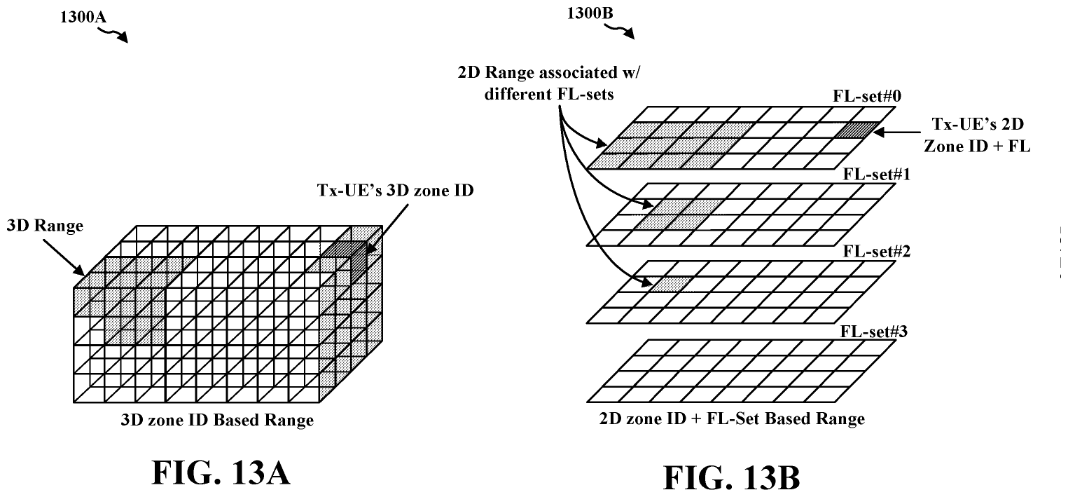

FIGS. 13A and 13B are diagrams 1300A and 1300B, respectively, illustrating zone-based 3D range control. A receiving aircraft UE may receive an SCI-2 message via a PSSCH. The SCI-2 message may include a zone-based indication of a 3D range. A receiving aircraft UE may be inside the communication range of a transmit aircraft UE when it is located within one of the indicated 3D zones. When the zone-based 3D range indication and control is utilized, the 3D zone ID of the transmit aircraft UE may or may not be indicated in the SCI-2 message because the range is explicitly indicated and the 3D zone ID of the transmit aircraft UE may not be necessary. FIG. 13A illustrates a zone-based indication of a 3D range where native 3D zone IDs are used. In one aspect, the size of the set of indicated 3D zones (e.g., the number of 3D zones) and the starting 3D zone ID of the set may be preconfigured via RRC signaling (e.g., received from a base station) and selected by the SCI-2 message. For example, a range indication may correspond to a cube or a sphere (ball) centered at a particular 3D zone as identified by a 3D zone ID.

FIG. 13B illustrates zone-based 3D range control where the 2D zone-based 3D zone IDs are used. The ranges may be indicated per FL. For each FL, the indication of the associated range may include a set of 2D zone IDs. In one aspect, the set of FLs as well as their associated sets of 2D zone IDs and the starting IDs of the sets may be preconfigured via RRC signaling (e.g., received from a base station) and selected by the SCI-2 message. For example, a range indication for a particular FL may correspond to a rectangle or a circle centered at a particular 2D zone as identified by a 2D zone ID. In one aspect, the SCI-2 message may be scheduled by an SCI-1 message, and the format of the SCI-2 message and/or the parameters associated with the 3D zone IDs may be indicated by the SCI-1 message in advance. For example, the SCI-1 message may indicate whether the 3D range is used, or which type of 3D range (e.g., distance-based or zone-based) is used.

In one aspect, a receiving aircraft UE may transmit a NACK feedback when it is within the indicated range and fails to decode the data portion of the PSSCH. A receiving aircraft UE may not transmit any feedback when it is outside the indicated range, so that no resources are wasted on retransmission attempts.

The zone-based 3D range indication may provide a simpler indication than the distance-based 3D range indication, especially when beamforming is considered, because the more complex angular spreads or 3D zone ID order may be avoided. However, the zone-based 3D range indication may be associated with a lower payload efficiency. In other words, more payload data may be transmitted in the SCI-2 message with the zone-based 3D range indication.

In one aspect, an aircraft UE may identify the range based on RRC-preconfigured range options (e.g., the “sl-TransRange” parameter in different releases) with values greater than 1 km. The RRC signaling may be received from a base station or from another aircraft UE. To support the expanded ATG network ranges, the existing range options may be reinterpreted. In one configuration, the existing range options may be reinterpreted by multiplying the existing range options by a factor (which may be RRC configured). In one configuration, one or more additional RRC parameters associated with an ATG base station for reinterpreting the existing range options may be indicated and identified. In one configuration, the reinterpretation of the existing range options may be dynamically indicated by the base station. In one configuration, one or more reserved range values may be redefined and used to indicate the expanded ATG network ranges.

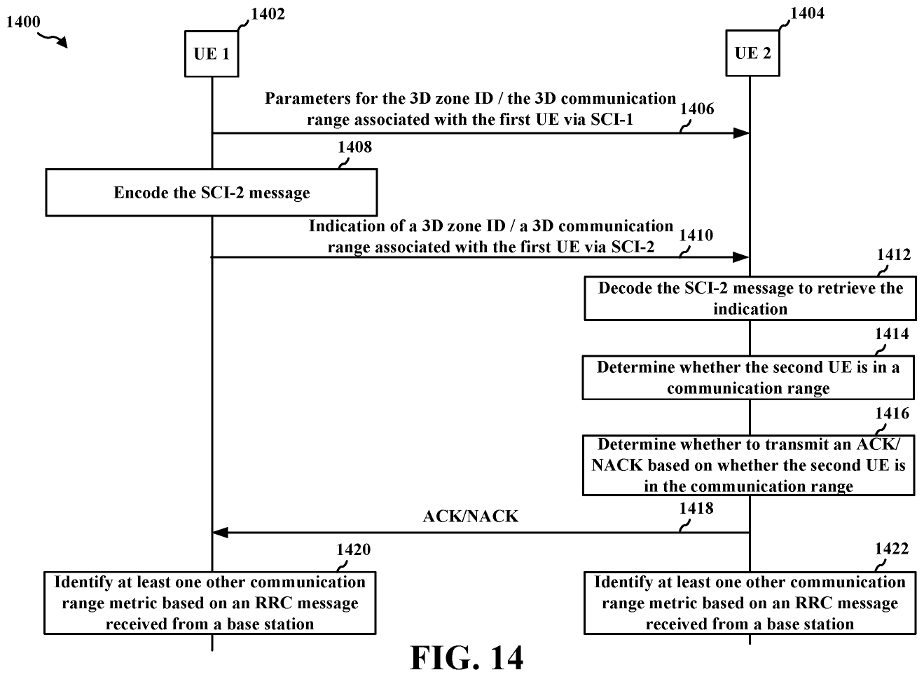

FIG. 14 is a communication flow 1400 of a method of wireless communication. The first UE 1402 may be a transmitting UE, and the second UE 1404 may be a receiving UE. At 1406, the first UE 1402 may transmit to the second UE 1404, and the second UE 1404 may receive from the first UE 1402, via an SCI-1 message in a PSCCH, one or more parameters for the at least one of the 3D zone ID associated with the first UE 1402 or the 3D communication range associated with the first UE 1402.

In one configuration, the 3D communication range associated with the first UE 1402 may be associated with one or more 3D zone IDs.

In one configuration, the 3D zone ID associated with the first UE 1402 may indicate a combination of a 2D zone ID associated with the first UE 1402 and at least one flight level associated with the first UE 1402.

In one configuration, the 3D communication range associated with the first UE 1402 may indicate one or more flight levels and one or more sets of 2D zone IDs, and each of the one or more flight levels may correspond to one of the one or more sets of 2D zone IDs.

In one configuration, a first flight level of the one or more flight levels may be closer to the at least one flight level associated with the first UE 1402 than a second flight level of the one or more flight levels, and a first set of the one or more sets of 2D zone IDs corresponding to the first flight level may correspond to a larger horizontal area than a second set of the one or more sets of 2D zone IDs corresponding to the second flight level.

In one configuration, the second set of 2D zone IDs may be represented in the indication as a difference between the first set of 2D zone IDs and the second set of 2D zone IDs.

In one configuration, the 3D communication range associated with the first UE 1402 may indicate at least one angular spread.

In one configuration, the at least one second UE 1404 may be in the communication range when the at least one second UE 1404 is within the at least one angular spread, and the at least one angular spread may include at least one of an azimuth angular spread or an elevation angular spread.

In one configuration, the 3D communication range associated with the first UE 1402 may be a 3D communication range metric.

In one configuration, the at least one of the 3D zone ID associated with the first UE 1402 or the 3D communication range associated with the first UE 1402 may be associated with ATA communication.

At 1408, the first UE 1402 may encode the SCI-2 message. The encoded SCI-2 message may include the indication of the at least one of the 3D zone ID associated with the first UE 1402 or the 3D communication range associated with the first UE 1402.

At 1410, the first UE 1402 may transmit to the second UE 1404, and the second UE 1404 may receive from the first UE 1402, via an SCI-2 message in a PSSCH, an indication of at least one of a 3D zone ID associated with the first UE 1402 or a 3D communication range associated with the first UE 1402.

At 1412, the second UE 1404 may decode the SCI-2 message to retrieve the indication of the at least one of the 3D zone ID associated with the first UE 1402 or the 3D communication range associated with the first UE 1402.

At 1414, the second UE 1404 may determine whether the second UE 1404 is in a communication range based on the received indication of the at least one of the 3D zone ID associated with the at least one first UE 1402 or the 3D communication range associated with the at least one first UE 1402.

At 1416, the second UE 1404 may determine whether to transmit an ACK or a NACK to the first UE 1402 based on whether the second UE 1404 is in the communication range.

At 1418, the second UE 1404 may transmit to the first UE 1402, and the first UE 1402 may receive from the second UE 1404, an ACK or a NACK based on whether the second UE 1404 is in the communication range or the determination of whether to transmit the ACK or the NACK.

At 1420, the first UE 1402 may identify at least one other communication range metric based on an RRC message received from a base station.

At 1422, the second UE 1404 may identify at least one other communication range metric based on an RRC message received from a base station.

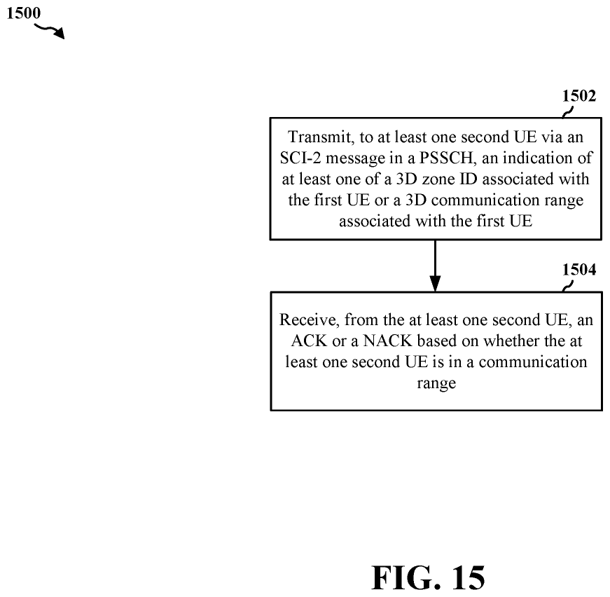

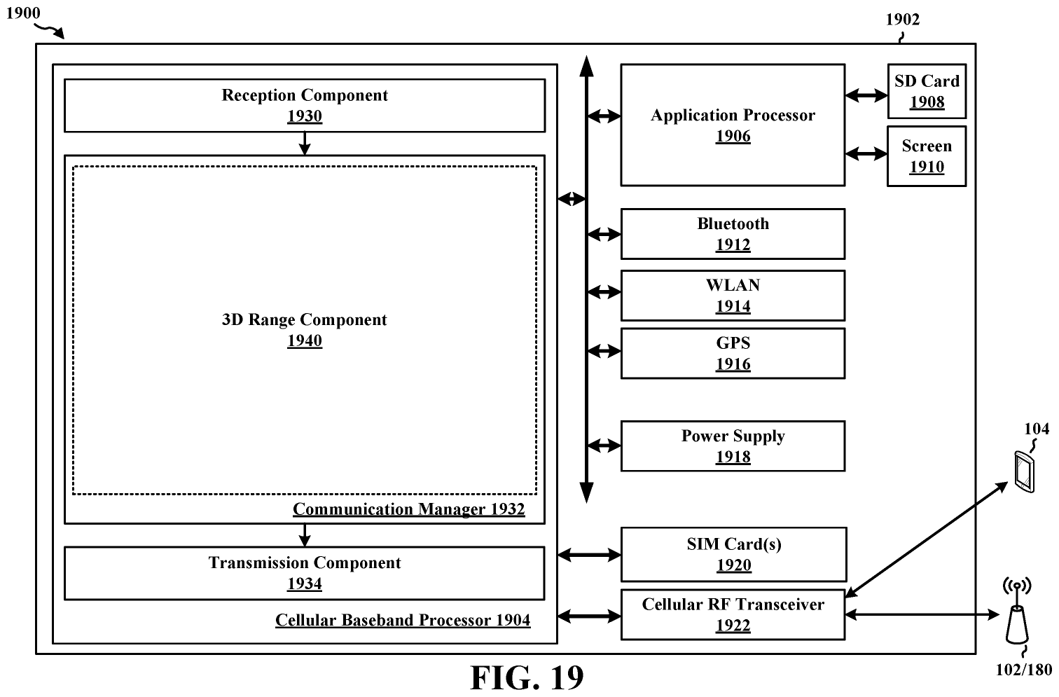

FIG. 15 is a flowchart 1500 of a method of wireless communication. The method may be performed by a first (transmitting) UE (e.g., the UE 104/350/1402; the apparatus 1902). At 1502, the first UE may transmit, to at least one second UE via an SCI-2 message in a PSSCH, an indication of at least one of a 3D zone ID associated with the first UE or a 3D communication range associated with the first UE. For example, 1502 may be performed by the 3D range component 1940 in FIG. 19. Referring to FIG. 14, at 1410, the first UE 1402 may transmit, to at least one second UE 1404 via an SCI-2 message in a PSSCH, an indication of at least one of a 3D zone ID associated with the first UE 1402 or a 3D communication range associated with the first UE 1402.

At 1504, the first UE may receive, from the at least one second UE, an ACK or a NACK based on whether the at least one second UE is in a communication range. For example, 1504 may be performed by the 3D range component 1940 in FIG. 19. Referring to FIG. 14, at 1418, the first UE 1402 may receive, from the at least one second UE 1404, an ACK or a NACK based on whether the at least one second UE 1404 is in a communication range.

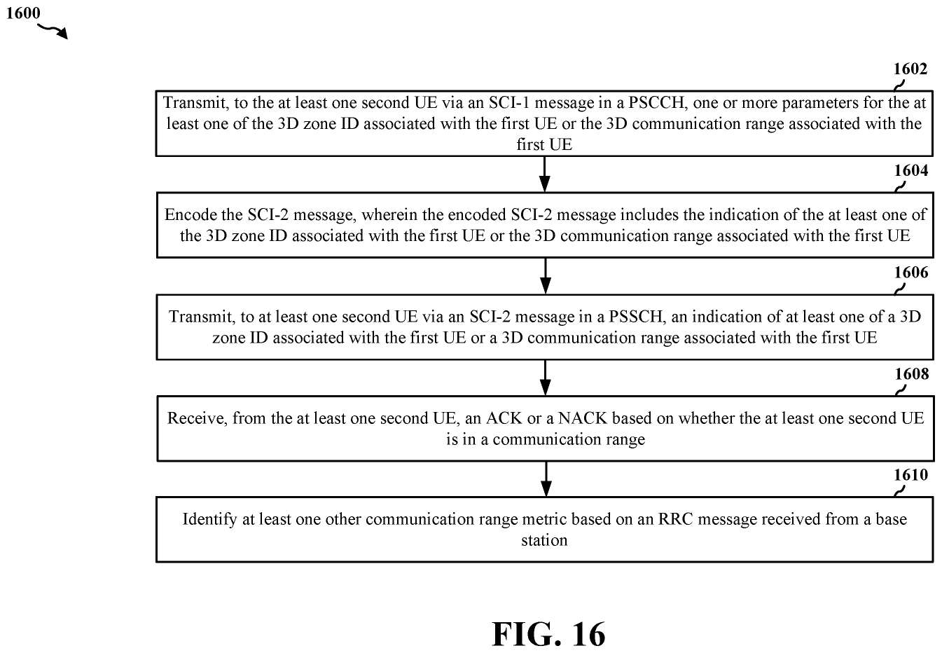

FIG. 16 is a flowchart 1600 of a method of wireless communication. The method may be performed by a first (transmitting) UE (e.g., the UE 104/350/1402; the apparatus 1902). At 1606, the first UE may transmit, to at least one second UE via an SCI-2 message in a PSSCH, an indication of at least one of a 3D zone ID associated with the first UE or a 3D communication range associated with the first UE. For example, 1606 may be performed by the 3D range component 1940 in FIG. 19. Referring to FIG. 14, at 1410, the first UE 1402 may transmit, to at least one second UE 1404 via an SCI-2 message in a PSSCH, an indication of at least one of a 3D zone ID associated with the first UE 1402 or a 3D communication range associated with the first UE 1402.

At 1608, the first UE may receive, from the at least one second UE, an ACK or a NACK based on whether the at least one second UE is in a communication range. For example, 1608 may be performed by the 3D range component 1940 in FIG. 19. Referring to FIG. 14, at 1418, the first UE 1402 may receive, from the at least one second UE 1404, an ACK or a NACK based on whether the at least one second UE 1404 is in a communication range.

In one configuration, at 1602, the first UE may transmit, to the at least one second UE via an SCI-1 message in a PSCCH, one or more parameters for the at least one of the 3D zone ID associated with the first UE or the 3D communication range associated with the first UE. For example, 1602 may be performed by the 3D range component 1940 in FIG. 19. Referring to FIG. 14, at 1406, the first UE 1402 may transmit, to the at least one second UE 1404 via an SCI-1 message in a PSCCH, one or more parameters for the at least one of the 3D zone ID associated with the first UE 1402 or the 3D communication range associated with the first UE 1402.

In one configuration, at 1604, the first UE may encode the SCI-2 message. The encoded SCI-2 message may include the indication of the at least one of the 3D zone ID associated with the first UE or the 3D communication range associated with the first UE. For example, 1604 may be performed by the 3D range component 1940 in FIG. 19. Referring to FIG. 14, at 1408, the first UE 1402 may encode the SCI-2 message. The encoded SCI-2 message may include the indication of the at least one of the 3D zone ID associated with the first UE 1402 or the 3D communication range associated with the first UE 1402.

In one configuration, the 3D communication range associated with the first UE may be associated with one or more 3D zone IDs.

In one configuration, the 3D zone ID associated with the first UE may indicate a combination of a 2D zone ID associated with the first UE and at least one flight level associated with the first UE.

In one configuration, the 3D communication range associated with the first UE may indicate one or more flight levels and one or more sets of 2D zone IDs, and each of the one or more flight levels may correspond to one of the one or more sets of 2D zone IDs.

In one configuration, a first flight level of the one or more flight levels may be closer to the at least one flight level associated with the first UE than a second flight level of the one or more flight levels, and a first set of the one or more sets of 2D zone IDs corresponding to the first flight level may correspond to a larger horizontal area than a second set of the one or more sets of 2D zone IDs corresponding to the second flight level.

In one configuration, the second set of 2D zone IDs may be represented in the indication as a difference between the first set of 2D zone IDs and the second set of 2D zone IDs.

In one configuration, the 3D communication range associated with the first UE may indicate at least one angular spread.

In one configuration, the at least one second UE may be in the communication range when the at least one second UE is within the at least one angular spread, and the at least one angular spread may include at least one of an azimuth angular spread or an elevation angular spread.

In one configuration, the 3D communication range associated with the first UE may be a 3D communication range metric.

In one configuration, at 1610, the first UE may identify at least one other communication range metric based on an RRC message received from a base station. For example, 1610 may be performed by the 3D range component 1940 in FIG. 19. Referring to FIG. 14, at 1420, the first UE 1402 may identify at least one other communication range metric based on an RRC message received from a base station.

In one configuration, the at least one of the 3D zone ID associated with the first UE or the 3D communication range associated with the first UE may be associated with ATA communication.

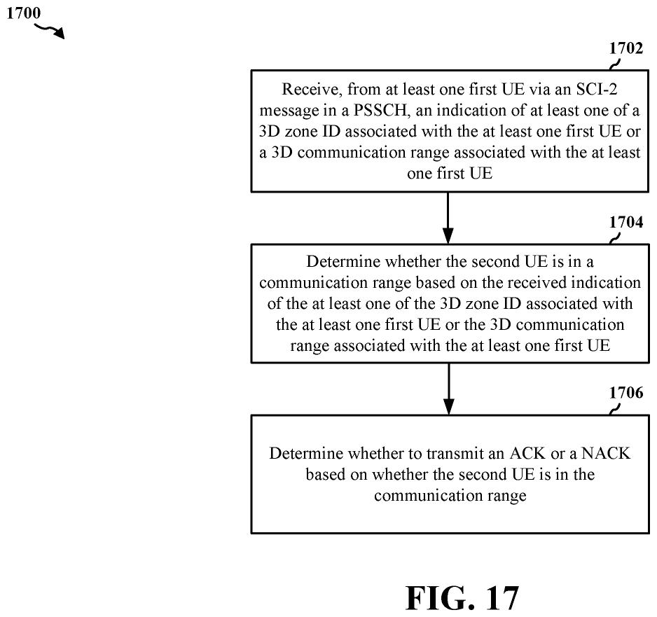

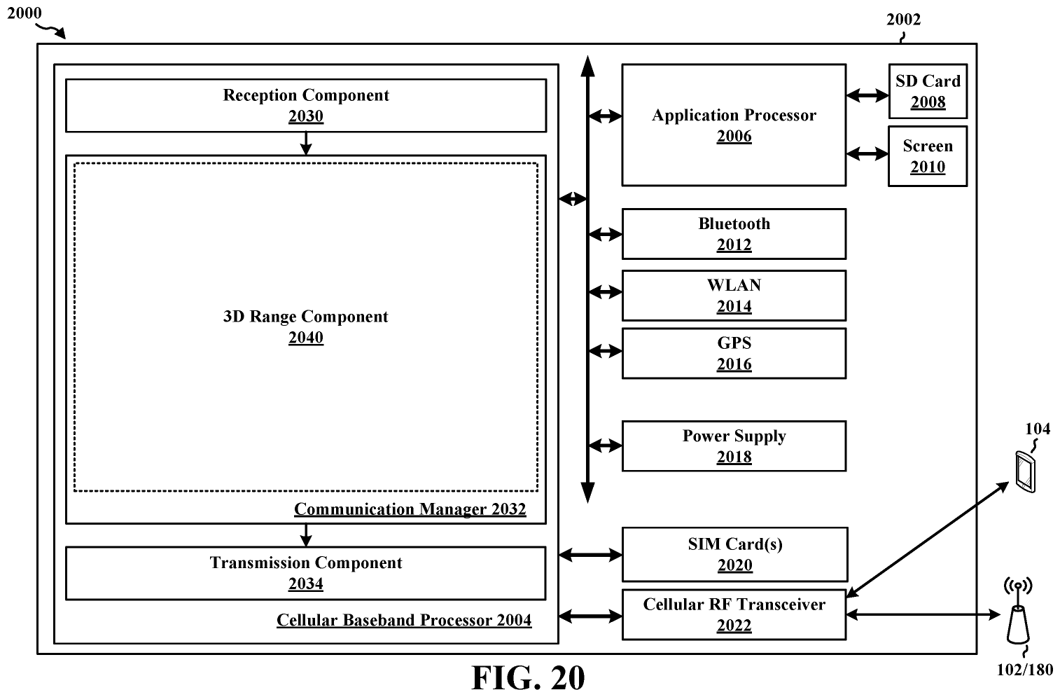

FIG. 17 is a flowchart 1700 of a method of wireless communication. The method may be performed by a second (receiving) UE (e.g., the UE 104′/350/1404; the apparatus 2002). At 1702, the second UE may receive, from at least one first UE via an SCI-2 message in a PSSCH, an indication of at least one of a 3D zone ID associated with the at least one first UE or a 3D communication range associated with the at least one first UE. For example, 1702 may be performed by the 3D range component 2040 in FIG. 20. Referring to FIG. 14, at 1410, the second UE 1404 may receive, from at least one first UE 1402 via an SCI-2 message in a PSSCH, an indication of at least one of a 3D zone ID associated with the at least one first UE 1402 or a 3D communication range associated with the at least one first UE 1402.

At 1704, the second UE may determine whether the second UE is in a communication range based on the received indication of the at least one of the 3D zone ID associated with the at least one first UE or the 3D communication range associated with the at least one first UE. For example, 1704 may be performed by the 3D range component 2040 in FIG. 20. Referring to FIG. 14, at 1414, the second UE 1404 may determine whether the second UE 1404 is in a communication range based on the received indication of the at least one of the 3D zone ID associated with the at least one first UE 1402 or the 3D communication range associated with the at least one first UE 1402.

At 1706, the second UE may determine whether to transmit an ACK or a NACK based on whether the second UE is in the communication range. For example, 1706 may be performed by the 3D range component 2040 in FIG. 20. Referring to FIG. 14, at 1416, the second UE 1404 may determine whether to transmit an ACK or a NACK based on whether the second UE 1404 is in the communication range.

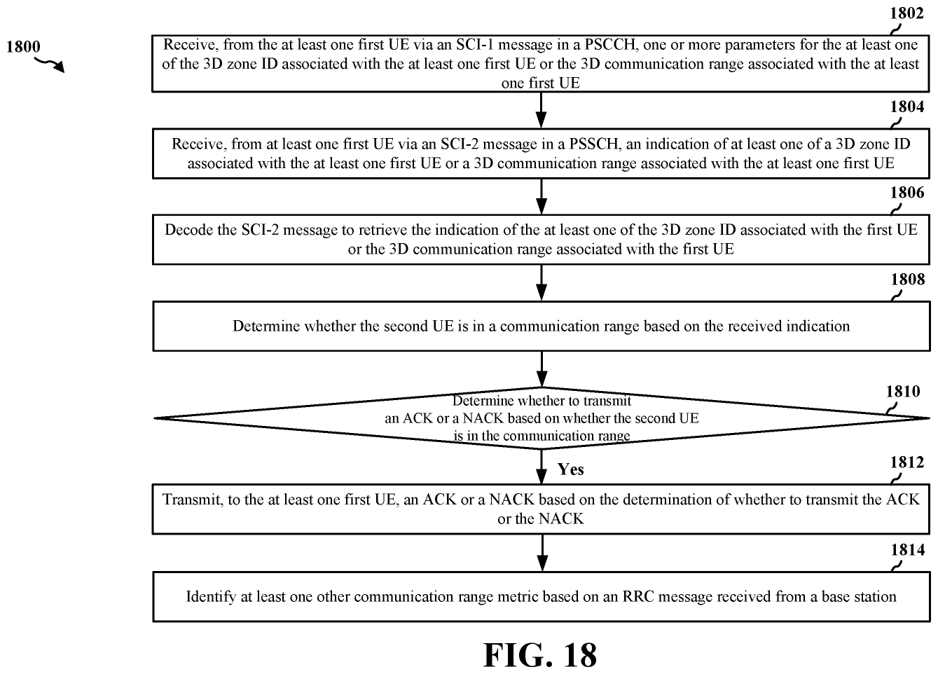

FIG. 18 is a flowchart 1800 of a method of wireless communication. The method may be performed by a second (receiving) UE (e.g., the UE 104′/350/1404; the apparatus 2002). At 1804, the second UE may receive, from at least one first UE via an SCI-2 message in a PSSCH, an indication of at least one of a 3D zone ID associated with the at least one first UE or a 3D communication range associated with the at least one first UE. For example, 1804 may be performed by the 3D range component 2040 in FIG. 20. Referring to FIG. 14, at 1410, the second UE 1404 may receive, from at least one first UE 1402 via an SCI-2 message in a PSSCH, an indication of at least one of a 3D zone ID associated with the at least one first UE 1402 or a 3D communication range associated with the at least one first UE 1402.

At 1808, the second UE may determine whether the second UE is in a communication range based on the received indication of the at least one of the 3D zone ID associated with the at least one first UE or the 3D communication range associated with the at least one first UE. For example, 1808 may be performed by the 3D range component 2040 in FIG. 20. Referring to FIG. 14, at 1414, the second UE 1404 may determine whether the second UE 1404 is in a communication range based on the received indication of the at least one of the 3D zone ID associated with the at least one first UE 1402 or the 3D communication range associated with the at least one first UE 1402.

At 1810, the second UE may determine whether to transmit an ACK or a NACK based on whether the second UE is in the communication range. For example, 1810 may be performed by the 3D range component 2040 in FIG. 20. Referring to FIG. 14, at 1416, the second UE 1404 may determine whether to transmit an ACK or a NACK based on whether the second UE 1404 is in the communication range.

In one configuration, at 1812, the second UE may transmit, to the at least one first UE, an ACK or a NACK based on the determination of whether to transmit the ACK or the NACK. For example, 1812 may be performed by the 3D range component 2040 in FIG. 20. Referring to FIG. 14, at 1418, the second UE 1404 may transmit, to the at least one first UE 1402, an ACK or a NACK based on the determination of whether to transmit the ACK or the NACK.

In one configuration, at 1802, the second UE may receive, from the at least one first UE via an SCI-1 message in a PSCCH, one or more parameters for the at least one of the 3D zone ID associated with the at least one first UE or the 3D communication range associated with the at least one first UE. For example, 1802 may be performed by the 3D range component 2040 in FIG. 20. Referring to FIG. 14, at 1406, the second UE 1404 may receive, from the at least one first UE 1402 via an SCI-1 message in a PSCCH, one or more parameters for the at least one of the 3D zone ID associated with the at least one first UE 1402 or the 3D communication range associated with the at least one first UE 1402.

In one configuration, at 1806, the second UE may decode the SCI-2 message to retrieve the indication of the at least one of the 3D zone ID associated with the first UE or the 3D communication range associated with the first UE. For example, 1806 may be performed by the 3D range component 2040 in FIG. 20. Referring to FIG. 14, at 1412, the second UE 1404 may decode the SCI-2 message to retrieve the indication of the at least one of the 3D zone ID associated with the first UE 1402 or the 3D communication range associated with the first UE 1402.

In one configuration, the 3D communication range associated with the first UE may be associated with one or more 3D zone IDs.

In one configuration, the 3D zone ID associated with the first UE may indicate a combination of a 2D zone ID associated with the first UE and at least one flight level associated with the first UE.

In one configuration, the 3D communication range associated with the first UE may indicate one or more flight levels and one or more sets of 2D zone IDs, and each of the one or more flight levels may correspond to one of the one or more sets of 2D zone IDs.

In one configuration, a first flight level of the one or more flight levels may be closer to the at least one flight level associated with the first UE than a second flight level of the one or more flight levels, and a first set of the one or more sets of 2D zone IDs corresponding to the first flight level may correspond to a larger horizontal area than a second set of the one or more sets of 2D zone IDs corresponding to the second flight level.

In one configuration, the second set of 2D zone IDs may be represented in the indication as a difference between the first set of 2D zone IDs and the second set of 2D zone IDs.

In one configuration, the 3D communication range associated with the first UE may indicate at least one angular spread.

In one configuration, the at least one second UE may be in the communication range when the at least one second UE is within the at least one angular spread, and the at least one angular spread may include at least one of an azimuth angular spread or an elevation angular spread.

In one configuration, the 3D communication range associated with the first UE may be a 3D communication range metric.

In one configuration, at 1814, the second UE may identify at least one other communication range metric based on an RRC message received from a base station. For example, 1814 may be performed by the 3D range component 2040 in FIG. 20. Referring to FIG. 14, at 1422, the second UE 1404 may identify at least one other communication range metric based on an RRC message received from a base station.

In one configuration, the at least one of the 3D zone ID associated with the first UE or the 3D communication range associated with the first UE may be associated with ATA communication.

FIG. 19 is a diagram 1900 illustrating an example of a hardware implementation for an apparatus 1902. The apparatus 1902 is a first (transmitting) UE and includes a cellular baseband processor 1904 (also referred to as a modem) coupled to a cellular RF transceiver 1922 and one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, and a power supply 1918. The cellular baseband processor 1904 communicates through the cellular RF transceiver 1922 with the UE 104 and/or BS 102/180. The cellular baseband processor 1904 may include a computer-readable medium/memory. The computer-readable medium/memory may be non-transitory. The cellular baseband processor 1904 is responsible for general processing, including the execution of software stored on the computer-readable medium/memory. The software, when executed by the cellular baseband processor 1904, causes the cellular baseband processor 1904 to perform the various functions described supra. The computer-readable medium/memory may also be used for storing data that is manipulated by the cellular baseband processor 1904 when executing software. The cellular baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the cellular baseband processor 1904. The cellular baseband processor 1904 may be a component of the UE 350 and may include the memory 360 and/or at least one of the TX processor 368, the RX processor 356, and the controller/processor 359. In one configuration, the apparatus 1902 may be a modem chip and include just the baseband processor 1904, and in another configuration, the apparatus 1902 may be the entire UE (e.g., see 350 of FIG. 3) and include the aforediscussed additional modules of the apparatus 1902.

The communication manager 1932 may include a 3D range component 1940 that may be configured to transmit, to the at least one second UE via an SCI-1 message in a PSCCH, one or more parameters for the at least one of the 3D zone ID associated with the first UE or the 3D communication range associated with the first UE, e.g., as described in connection with 1602 in FIG. 16. The 3D range component 1940 that may be configured to encode the SCI-2 message, where the encoded SCI-2 message may include the indication of the at least one of the 3D zone ID associated with the first UE or the 3D communication range associated with the first UE, e.g., as described in connection with 1604 in FIG. 16. The 3D range component 1940 that may be configured to transmit, to at least one second UE via an SCI-2 message in a PSSCH, an indication of at least one of a 3D zone ID associated with the first UE or a 3D communication range associated with the first UE, e.g., as described in connection with 1606 in FIG. 16. The 3D range component 1940 that may be configured to receive, from the at least one second UE, an ACK or a NACK based on whether the at least one second UE is in a communication range, e.g., as described in connection with 1608 in FIG. 16. The 3D range component 1940 that may be configured to identify at least one other communication range metric based on an RRC message received from a base station, e.g., as described in connection with 1610 in FIG. 16.

The apparatus may include additional components that perform each of the blocks of the algorithm in the aforementioned flowcharts of FIGS. 14-16. As such, each block in the aforementioned flowcharts of FIGS. 14-16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1902, and in particular the cellular baseband processor 1904, includes means for transmitting, to at least one second UE via an SCI-2 message in a PSSCH, an indication of at least one of a 3D zone ID associated with the first UE or a 3D communication range associated with the first UE. The apparatus 1902 may include means for receiving, from the at least one second UE, an ACK or a NACK based on whether the at least one second UE is in a communication range.

In one configuration, the apparatus 1902 may further include means for transmitting, to the at least one second UE via an SCI-1 message in a PSCCH, one or more parameters for the at least one of the 3D zone ID associated with the first UE or the 3D communication range associated with the first UE. In one configuration, the apparatus 1902 may further include means for encoding the SCI-2 message, where the encoded SCI-2 message may include the indication of the at least one of the 3D zone ID associated with the first UE or the 3D communication range associated with the first UE. In one configuration, the 3D communication range associated with the first UE may be associated with one or more 3D zone IDs. In one configuration, the 3D zone ID associated with the first UE may indicate a combination of a 2D zone ID associated with the first UE and at least one flight level associated with the first UE. In one configuration, the 3D communication range associated with the first UE may indicate one or more flight levels and one or more sets of 2D zone IDs, and each of the one or more flight levels may correspond to one of the one or more sets of 2D zone IDs. In one configuration, a first flight level of the one or more flight levels may be closer to the at least one flight level associated with the first UE than a second flight level of the one or more flight levels, and a first set of the one or more sets of 2D zone IDs corresponding to the first flight level may correspond to a larger horizontal area than a second set of the one or more sets of 2D zone IDs corresponding to the second flight level. In one configuration, the second set of 2D zone IDs may be represented in the indication as a difference between the first set of 2D zone IDs and the second set of 2D zone IDs. In one configuration, the 3D communication range associated with the first UE may indicate at least one angular spread. In one configuration, the at least one second UE may be in the communication range when the at least one second UE is within the at least one angular spread, and the at least one angular spread may include at least one of an azimuth angular spread or an elevation angular spread. In one configuration, the 3D communication range associated with the first UE may be a 3D communication range metric. In one configuration, the apparatus 1902 may further include means for identifying at least one other communication range metric based on an RRC message received from a base station. In one configuration, the at least one of the 3D zone ID associated with the first UE or the 3D communication range associated with the first UE may be associated with ATA communication.

The aforementioned means may be one or more of the aforementioned components of the apparatus 1902 configured to perform the functions recited by the aforementioned means. As described supra, the apparatus 1902 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 20 is a diagram 2000 illustrating an example of a hardware implementation for an apparatus 2002. The apparatus 2002 is a second (receiving) UE and includes a cellular baseband processor 2004 (also referred to as a modem) coupled to a cellular RF transceiver 2022 and one or more subscriber identity modules (SIM) cards 2020, an application processor 2006 coupled to a secure digital (SD) card 2008 and a screen 2010, a Bluetooth module 2012, a wireless local area network (WLAN) module 2014, a Global Positioning System (GPS) module 2016, and a power supply 2018. The cellular baseband processor 2004 communicates through the cellular RF transceiver 2022 with the UE 104 and/or BS 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004. The cellular baseband processor 2004 may be a component of the UE 350 and may include the memory 360 and/or at least one of the TX processor 368, the RX processor 356, and the controller/processor 359. In one configuration, the apparatus 2002 may be a modem chip and include just the baseband processor 2004, and in another configuration, the apparatus 2002 may be the entire UE (e.g., see 350 of FIG. 3) and include the aforediscussed additional modules of the apparatus 2002.

The communication manager 2032 may include a 3D range component 2040 that may be configured to receive, from the at least one first UE via an SCI-1 message in a PSCCH, one or more parameters for the at least one of the 3D zone ID associated with the at least one first UE or the 3D communication range associated with the at least one first UE, e.g., as described in connection with 1802 in FIG. 18. The 3D range component 2040 that may be configured to receive, from at least one first UE via an SCI-2 message in a PSSCH, an indication of at least one of a 3D zone ID associated with the at least one first UE or a 3D communication range associated with the at least one first UE, e.g., as described in connection with 1804 in FIG. 18. The 3D range component 2040 that may be configured to decode the SCI-2 message to retrieve the indication of the at least one of the 3D zone ID associated with the first UE or the 3D communication range associated with the first UE, e.g., as described in connection with 1806 in FIG. 18. The 3D range component 2040 that may be configured to determine whether the second UE is in a communication range based on the received indication of the at least one of the 3D zone ID associated with the at least one first UE or the 3D communication range associated with the at least one first UE, e.g., as described in connection with 1808 in FIG. 18. The 3D range component 2040 that may be configured to determine whether to transmit an ACK or a NACK based on whether the second UE is in the communication range, e.g., as described in connection with 1810 in FIG. 18. The 3D range component 2040 that may be configured to transmit, to the at least one first UE, an ACK or a NACK based on the determination of whether to transmit the ACK or the NACK, e.g., as described in connection with 1812 in FIG. 18. The 3D range component 2040 that may be configured to identify at least one other communication range metric based on an RRC message received from a base station, e.g., as described in connection with 1814 in FIG. 18.

The apparatus may include additional components that perform each of the blocks of the algorithm in the aforementioned flowcharts of FIGS. 14, 17, and 18. As such, each block in the aforementioned flowcharts of FIGS. 14, 17, and 18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the cellular baseband processor 2004, includes means for receiving, from at least one first UE via an SCI-2 message in a PSSCH, an indication of at least one of a 3D zone ID associated with the at least one first UE or a 3D communication range associated with the at least one first UE. The apparatus 2002 may include means for determining whether the second UE is in a communication range based on the received indication of the at least one of the 3D zone ID associated with the at least one first UE or the 3D communication range associated with the at least one first UE. The apparatus 2002 may include means for determining whether to transmit an ACK or a NACK based on whether the second UE is in the communication range.

In one configuration, the apparatus 2002 may further include means for transmitting, to the at least one first UE, an ACK or a NACK based on the determination of whether to transmit the ACK or the NACK. In one configuration, the apparatus 2002 may further include means for receiving, from the at least one first UE via an SCI-1 message in a PSCCH, one or more parameters for the at least one of the 3D zone ID associated with the at least one first UE or the 3D communication range associated with the at least one first UE. In one configuration, the apparatus 2002 may further include means for decoding the SCI-2 message to retrieve the indication of the at least one of the 3D zone ID associated with the first UE or the 3D communication range associated with the first UE. In one configuration, the 3D communication range associated with the first UE may be associated with one or more 3D zone IDs. In one configuration, the 3D zone ID associated with the first UE may indicate a combination of a 2D zone ID associated with the first UE and at least one flight level associated with the first UE. In one configuration, the 3D communication range associated with the first UE may indicate one or more flight levels and one or more sets of 2D zone IDs, and each of the one or more flight levels may correspond to one of the one or more sets of 2D zone IDs. In one configuration, a first flight level of the one or more flight levels may be closer to the at least one flight level associated with the first UE than a second flight level of the one or more flight levels, and a first set of the one or more sets of 2D zone IDs corresponding to the first flight level may correspond to a larger horizontal area than a second set of the one or more sets of 2D zone IDs corresponding to the second flight level. In one configuration, the second set of 2D zone IDs may be represented in the indication as a difference between the first set of 2D zone IDs and the second set of 2D zone IDs. In one configuration, the 3D communication range associated with the first UE may indicate at least one angular spread. In one configuration, the at least one second UE may be in the communication range when the at least one second UE is within the at least one angular spread, and the at least one angular spread may include at least one of an azimuth angular spread or an elevation angular spread. In one configuration, the 3D communication range associated with the first UE may be a 3D communication range metric. In one configuration, the apparatus 2002 may further include means for identifying at least one other communication range metric based on an RRC message received from a base station. In one configuration, the at least one of the 3D zone ID associated with the first UE or the 3D communication range associated with the first UE may be associated with ATA communication.

The aforementioned means may be one or more of the aforementioned components of the apparatus 2002 configured to perform the functions recited by the aforementioned means. As described supra, the apparatus 2002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The first UE may transmit to the second UE, via an SCI-2 message in a PSSCH, an indication of at least one of a 3D zone ID associated with the first UE or a 3D communication range associated with the first UE. The second UE may determine whether the second UE is in a communication range based on the received indication of the at least one of the 3D zone ID associated with the at least one first UE or the 3D communication range associated with the at least one first UE. The second UE may determine whether to transmit an ACK or a NACK based on whether the second UE is in the communication range. The second UE may transmit to the first UE an ACK or a NACK based on whether the at least one second UE is in a communication range. In particular, if the second UE is within the communication range of the first UE, the second UE may transmit an ACK or a NACK depending on whether a PSSCH has been fully decoded. If the second UE is outside the communication range of the first UE, the second UE may not transmit any ACK or NACK. The first UE and the second UE may be aircraft UEs. Accordingly, proper range control in the 3D airspace may be achieved. Resource waste associated with retransmissions caused by inappropriately transmitted NACKs by out-of-coverage second UEs may be avoided.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a first UE, including: transmitting, to at least one second UE via an SCI-2 message in a PSSCH, an indication of at least one of a 3D zone ID associated with the first UE or a 3D communication range associated with the first UE; and receiving, from the at least one second UE, an ACK or a NACK based on whether the at least one second UE is in a communication range.

Aspect 2 is the method of aspect 1, further including: transmitting, to the at least one second UE via an SCI-1 message in a PSCCH, one or more parameters for the at least one of the 3D zone ID associated with the first UE or the 3D communication range associated with the first UE.

Aspect 3 is the method of any of aspects 1 and 2, further including: encoding the SCI-2 message, where the encoded SCI-2 message includes the indication of the at least one of the 3D zone ID associated with the first UE or the 3D communication range associated with the first UE.

Aspect 4 is the method of any of aspects 1 to 3, where the 3D communication range associated with the first UE is associated with one or more 3D zone IDs.

Aspect 5 is the method of any of aspects 1 to 3, where the 3D zone ID associated with the first UE indicates a combination of a 2D zone ID associated with the first UE and at least one flight level associated with the first UE.

Aspect 6 is the method of aspect 5, where the 3D communication range associated with the first UE indicates one or more flight levels and one or more sets of 2D zone IDs, and each of the one or more flight levels corresponds to one of the one or more sets of 2D zone IDs.

Aspect 7 is the method of aspect 6, where a first flight level of the one or more flight levels is closer to the at least one flight level associated with the first UE than a second flight level of the one or more flight levels, and a first set of the one or more sets of 2D zone IDs corresponding to the first flight level corresponds to a larger horizontal area than a second set of the one or more sets of 2D zone IDs corresponding to the second flight level.

Aspect 8 is the method of aspect 7, where the second set of 2D zone IDs are represented in the indication as a difference between the first set of 2D zone IDs and the second set of 2D zone IDs.

Aspect 9 is the method of any of aspects 1 to 5, where the 3D communication range associated with the first UE indicates at least one angular spread.

Aspect 10 is the method of aspect 9, where the at least one second UE is in the communication range when the at least one second UE is within the at least one angular spread, and the at least one angular spread includes at least one of an azimuth angular spread or an elevation angular spread.

Aspect 11 is the method of any of aspects 1 to 10, where the 3D communication range associated with the first UE is a 3D communication range metric.

Aspect 12 is the method of aspect 11, further including: identifying at least one other communication range metric based on an RRC message received from a base station.

Aspect 13 is the method of any of aspects 1 to 12, where the at least one of the 3D zone ID associated with the first UE or the 3D communication range associated with the first UE is associated with ATA communication.

Aspect 14 is a method of wireless communication at a second UE, including: receiving, from at least one first UE via an SCI-2 message in a PSSCH, an indication of at least one of a 3D zone ID associated with the at least one first UE or a 3D communication range associated with the at least one first UE; determining whether the second UE is in a communication range based on the received indication of the at least one of the 3D zone ID associated with the at least one first UE or the 3D communication range associated with the at least one first UE; and determining whether to transmit an ACK or a NACK based on whether the second UE is in the communication range.

Aspect 15 is the method of aspect 14, further including: transmitting, to the at least one first UE, an ACK or a NACK based on the determination of whether to transmit the ACK or the NACK.

Aspect 16 is the method of any of aspects 14 and 15, further including: receiving, from the at least one first UE via an SCI-1 message in a PSCCH, one or more parameters for the at least one of the 3D zone ID associated with the at least one first UE or the 3D communication range associated with the at least one first UE.

Aspect 17 is the method of any of aspects 14 to 16, further including: decoding the SCI-2 message to retrieve the indication of the at least one of the 3D zone ID associated with the first UE or the 3D communication range associated with the first UE.

Aspect 18 is the method of any of aspects 14 to 17, where the 3D communication range associated with the at least one first UE is associated with one or more 3D zone IDs.

Aspect 19 is the method of any of aspects 14 to 17, where the 3D zone ID associated with the at least one first UE indicates a combination of a 2D zone ID associated with the at least one first UE and at least one flight level associated with the at least one first UE.

Aspect 20 is the method of aspect 19, where the 3D communication range associated with the at least one first UE indicates one or more flight levels and one or more sets of 2D zone IDs, and each of the one or more flight levels corresponds to one of the one or more sets of 2D zone IDs.

Aspect 21 is the method of aspect 20, where a first flight level of the one or more flight levels is closer to the at least one flight level associated with the at least one first UE than a second flight level of the one or more flight levels, and a first set of the one or more sets of 2D zone IDs corresponding to the first flight level corresponds to a larger horizontal area than a second set of the one or more sets of 2D zone IDs corresponding to the second flight level.

Aspect 22 is the method of aspect 21, where the second set of 2D zone IDs are represented in the indication as a difference between the first set of 2D zone IDs and the second set of 2D zone IDs.

Aspect 23 is the method of any of aspects 14 to 19, where the 3D communication range associated with the at least one first UE indicates at least one angular spread.

Aspect 24 is the method of aspect 23, where the second UE is in the communication range when the second UE is within the at least one angular spread, and the at least one angular spread includes at least one of an azimuth angular spread or an elevation angular spread.

Aspect 25 is the method of any of aspects 14 to 24, where the 3D communication range associated with the at least one first UE is a 3D communication range metric.

Aspect 26 is the method of aspect 25, further including: identifying at least one other communication range metric based on an RRC message received from a base station.

Aspect 27 is the method of any of aspects 14 to 26, where the at least one of the 3D zone ID associated with the at least one first UE or the 3D communication range associated with the at least one first UE is associated with ATA communication.

Aspect 28 is an apparatus for wireless communication including at least one processor coupled to a memory and configured to implement a method as in any of aspects 1 to 27.

Aspect 29 is an apparatus for wireless communication including means for implementing a method as in any of aspects 1 to 27.

Aspect 30 is a computer-readable medium storing computer executable code, where the code when executed by a processor causes the processor to implement a method as in any of aspects 1 to 27.

What is claimed is:

1. An apparatus for wireless communication at a first user equipment (UE), comprising:
a memory; and
at least one processor coupled to the memory and configured to:
transmit, to at least one second UE via a sidelink control information (SCI) format 2 (SCI-2) message in a physical sidelink shared channel (PSSCH), an indication of at least one of a three-dimensional (3D) zone identifier (ID) associated with the first UE or a 3D communication range associated with the first UE; and
receive, from the at least one second UE, an acknowledgement (ACK) or a negative acknowledgement (NACK) based on whether the at least one second UE is in a communication range.

2. The apparatus of claim 1, the at least one processor being further configured to:
transmit, to the at least one second UE via an SCI format 1 (SCI-1) message in a physical sidelink control channel (PSCCH), one or more parameters for the at least one of the 3D zone ID associated with the first UE or the 3D communication range associated with the first UE.

3. The apparatus of claim 1, the at least one processor being further configured to:
encode the SCI-2 message, wherein the encoded SCI-2 message includes the indication of the at least one of the 3D zone ID associated with the first UE or the 3D communication range associated with the first UE.

4. The apparatus of claim 1, wherein the 3D communication range associated with the first UE is associated with one or more 3D zone IDs.

5. The apparatus of claim 1, wherein the 3D zone ID associated with the first UE indicate s a combination of a two-dimensional (2D) zone ID associated with the first UE and at least one flight level associated with the first UE.

6. The apparatus of claim 5, wherein the 3D communication range associated with the first UE indicates one or more flight levels and one or more sets of 2D zone IDs, and each of the one or more flight levels corresponds to one of the one or more sets of 2D zone IDs.

7. The apparatus of claim 6, wherein a first flight level of the one or more flight levels is closer to the at least one flight level associated with the first UE than a second flight level of the one or more flight levels, and a first set of the one or more sets of 2D zone IDs corresponding to the first flight level corresponds to a larger horizontal area than a second set of the one or more sets of 2D zone IDs corresponding to the second flight level.

8. The apparatus of claim 7, wherein the second set of 2D zone IDs are represented in the indication as a difference between the first set of 2D zone IDs and the second set of 2D zone IDs.

9. The apparatus of claim 1, wherein the 3D communication range associated with the first UE indicates at least one angular spread.

10. The apparatus of claim 9, wherein the at least one second UE is in the communication range when the at least one second UE is within the at least one angular spread, and the at least one angular spread comprises at least one of an azimuth angular spread or an elevation angular spread.

11. The apparatus of claim 1, wherein the 3D communication range associated with the first UE is a 3D communication range metric.

12. The apparatus of claim 11, the at least one processor being further configured to:
identify at least one other communication range metric based on a radio resource control (RRC) message received from a base station.

13. The apparatus of claim 1, wherein the at least one of the 3D zone ID associated with the first UE or the 3D communication range associated with the first UE is associated with air-to-air (ATA) communication.

14. A method of wireless communication at a first user equipment (UE), comprising:
transmitting, to at least one second UE via a sidelink control information (SCI) format 2 (SCI-2) message in a physical sidelink shared channel (PSSCH), an indication of at least one of a three-dimensional (3D) zone identifier (ID) associated with the first UE or a 3D communication range associated with the first UE; and
receiving, from the at least one second UE, an acknowledgement (ACK) or a negative acknowledgement (NACK) based on whether the at least one second UE is in a communication range.

15. The method of claim 14, further comprising:
transmitting, to the at least one second UE via an SCI format 1 (SCI-1) message in a physical sidelink control channel (PSCCH), one or more parameters for the at least one of the 3D zone ID associated with the first UE or the 3D communication range associated with the first UE.

16. An apparatus for wireless communication at a second user equipment (UE), comprising:
a memory; and
at least one processor coupled to the memory and configured to:
receive, from at least one first UE via a sidelink control information (SCI) format 2 (SCI-2) message in a physical sidelink shared channel (PSSCH), an indication of at least one of a three-dimensional (3D) zone identifier (ID) associated with the at least one first UE or a 3D communication range associated with the at least one first UE;
determine whether the second UE is in a communication range based on the received indication of the at least one of the 3D zone ID associated with the at least one first UE or the 3D communication range associated with the at least one first UE; and
determine whether to transmit an acknowledgement (ACK) or a negative acknowledgement (NACK) based on whether the second UE is in the communication range.

17. The apparatus of claim 16, the at least one processor being further configured to:
transmit, to the at least one first UE, an ACK or a NACK based on the determination of whether to transmit the ACK or the NACK.

18. The apparatus of claim 16, the at least one processor being further configured to:
receive, from the at least one first UE via an SCI format 1 (SCI-1) message in a physical sidelink control channel (PSCCH), one or more parameters for the at least one of the 3D zone ID associated with the at least one first UE or the 3D communication range associated with the at least one first UE.

19. The apparatus of claim 16, the at least one processor being further configured to:
decode the SCI-2 message to retrieve the indication of the at least one of the 3D zone ID associated with the first UE or the 3D communication range associated with the first UE.

20. The apparatus of claim 16, wherein the 3D communication range associated with the at least one first UE is associated with one or more 3D zone IDs.

21. The apparatus of claim 16, wherein the 3D zone ID associated with the at least one first UE indicates a combination of a two-dimensional (2D) zone ID associated with the at least one first UE and at least one flight level associated with the at least one first UE.

22. The apparatus of claim 21, wherein the 3D communication range associated with the at least one first UE indicates one or more flight levels and one or more sets of 2D zone IDs, and each of the one or more flight levels corresponds to one of the one or more sets of 2D zone IDs.

23. The apparatus of claim 22, wherein a first flight level of the one or more flight levels is closer to the at least one flight level associated with the at least one first UE than a second flight level of the one or more flight levels, and a first set of the one or more sets of 2D zone IDs corresponding to the first flight level corresponds to a larger horizontal area than a second set of the one or more sets of 2D zone IDs corresponding to the second flight level.

24. The apparatus of claim 23, wherein the second set of 2D zone IDs are represented in the indication as a difference between the first set of 2D zone IDs and the second set of 2D zone IDs.

25. The apparatus of claim 16, wherein the 3D communication range associated with the at least one first UE indicates at least one angular spread.

26. The apparatus of claim 25, wherein the second UE is in the communication range when the second UE is within the at least one angular spread, and the at least one angular spread comprises at least one of an azimuth angular spread or an elevation angular spread.

27. The apparatus of claim 16, wherein the 3D communication range associated with the at least one first UE is a 3D communication range metric.

28. The apparatus of claim 27, the at least one processor being further configured to:
identify at least one other communication range metric based on a radio resource control (RRC) message received from a base station.

29. The apparatus of claim 16, wherein the at least one of the 3D zone ID associated with the at least one first UE or the 3D communication range associated with the at least one first UE is associated with air-to-air (ATA) communication.

30. A method of wireless communication at a second user equipment (UE), comprising:
receiving, from at least one first UE via a sidelink control information (SCI) format 2 (SCI-2) message in a physical sidelink shared channel (PSSCH), an indication of at least one of a three-dimensional (3D) zone identifier (ID) associated with the at least one first UE or a 3D communication range associated with the at least one first UE;
determining whether the second UE is in a communication range based on the received indication of the at least one of the 3D zone ID associated with the at least one first UE or the 3D communication range associated with the at least one first UE; and
determining whether to transmit an acknowledgement (ACK) or a negative acknowledgement (NACK) based on whether the second UE is in the communication range.
